(19) United States
(12) Patent Application Publication
(10) Pub. No.: US 2026/0270192 A1
(43) Pub. Date: Sep. 10, 2026

(54) Supervisor Switchover with Reduced Data Plane Traffic Loss

(71) Applicant: Arista Networks, Inc., Santa Clara, CA (US)

(72) Inventors: Karankumar Jagjitkumar, Maple Ridge (CA); Avininderpal Singh Grewal, Langley (CA); Purushothaman Nandakumaran, Milpitas, CA (US); Terence King Lam Hui, Vancouver (CA); Swaroop George, Bangalore (IN); Deepjyoti Kakati, Bangalore (IN)

(21) Appl. No.: 19/071,600

(22) Filed: Mar. 5, 2025

(51) Int. Cl. H04L 45/24; H04L 45/42

(52) U.S. Cl. CPC H04L 45/245; H04L 45/42

(57) ABSTRACT

A network device may include an active supervisor and a standby supervisor. The active supervisor module implementing the active supervisor may include data plane components. In some scenarios, when initiating a switchover that promotes the standby supervisor to a new active supervisor, the data plane components of the outgoing active supervisor module may be removed or become non-operational. To reduce traffic loss due to the lost data plane components, the active supervisor, prior to the switchover, may determine data hardware states in anticipation of loss of the data plane components and facilitate the programming of these data hardware states into corresponding data plane processor(s) of the network device prior to switchover initiation and/or prior to completion of the switchover.

### BACKGROUND

A communication system can include network devices that are interconnected to form a network for conveying network traffic from source devices to destination devices. A network device can be, or form part of, a modular system. Multiple supervisor modules, such as a first supervisor module configured as an active supervisor module and a second supervisor module configured as a standby supervisor module, are often provided in the modular system. Doing so can provide supervisor redundancy for the modular system. However, for some types of supervisor modules, certain issues may arise when switching operations from an active supervisor module to a standby supervisor module.

### BRIEF DESCRIPTION OF THE DRAWINGS

FIG. 1 is a diagram of an illustrative network device in a networking system in accordance with some embodiments.

FIG. 2 is a diagram of illustrative network device control circuitry being implemented using multiple control plane supervisors in accordance with some embodiments.

FIG. 3 is a diagram of an illustrative supervisor module that provides a control plane supervisor and data plane components in accordance with some embodiments.

FIG. 4 is a diagram of an illustrative modular implementation of a network device formed from multiple supervisor modules in accordance with some embodiments.

FIG. 5 is a diagram of an illustrative active supervisor providing information to a standby supervisor in preparation for loss of active supervisor module data plane components in accordance with some embodiments.

FIG. 6 is a diagram of an illustrative new active supervisor module detecting data plane processor(s) of a previous active supervisor module being inactive in accordance with some embodiments.

FIG. 7 is a diagram of illustrative data plane processor(s) being programmed based on the loss of some data plane component(s) in accordance with some embodiments.

FIG. 8 is a diagram of illustrative types of updates to the programming of data plane processor(s) in accordance with some embodiments.

FIG. 9 is a diagram of an illustrative active supervisor programming backup information onto data plane processor(s) in preparation for loss of active supervisor module data plane components in accordance with some embodiments.

FIG. 10 is a flowchart of illustrative operations for operating supervisor module(s) to facilitate switchover when the previous active supervisor module includes data plane components(s) in accordance with some embodiments.

### DETAILED DESCRIPTION

A network may include numerous interconnected network devices that process network traffic in a desired manner. A network device can sometimes include multiple supervisors, one serving as an active supervisor that currently controls the operation of the network device (e.g., data plane processors therein) and one serving as a standby supervisor that can take over the role of the active supervisor to control the operation of the network device, e.g., if a supervisor module containing the currently active supervisor is removed from the network device, or generally when a switchover criterion is satisfied such as a criterion indicative of an unexpected failure of the currently active supervisor, a criterion indicative of a planned maintenance event of the currently active supervisor, etc.

In some illustrative configurations described herein as an example, a supervisor module may include a control plane processor implementing an (active or standby) supervisor and may additionally include data plane processor(s) and data plane interface(s) (e.g., ports) for handling (e.g., forwarding) data plane traffic. While providing data plane components on the supervisor modules can improve their functionality, issues may arise during switchover from an active supervisor module to a standby supervisor module. This may, for example, be caused by the entire active supervisor module being removed (e.g., pulled out and disconnected) from the chassis of the (modular) network device. While stateful switchover and graceful restart of protocols may be performed by the new active (previous standby) supervisor to properly take over control of the network device, the loss of the previous active supervisor module also causes link down events at the data plane interfaces of the previous active supervisor module. Only after graceful restart has been completed will the new active supervisor take into account the loss of the data plane interfaces of the previous active supervisor module. This process can however cause prolonged outage, e.g., caused by blackholing of traffic at the no longer present data plane interfaces.

To mitigate these issues, the active supervisor may be configured to provide instructions to the standby supervisor (and/or program backup states on data plane processors in the network device) in anticipation of loss of data plane components of the active supervisor module prior to the switchover. In such a manner, when the switchover occurs and the standby supervisor becomes the new active supervisor, the operating states of data plane processors may be updated (e.g., based on the previous instructions provided by the old active supervisor) to states that incorporate the loss of the data plane components on the previous active supervisor module. This update may be performed by the new active supervisor prior to completion of the switchover operation (e.g., prior to graceful restart operations, at or near the beginning of the switchover operation, etc.) and may therefore reduce outage time (e.g., the time period of data plane traffic loss caused by blackholing of traffic at data plane components of the previous active supervisor module). The reduction in outage time is at least in part because the new active supervisor no longer needs to wait for hardware and protocol state convergence (e.g., resulting from completion of graceful restart as part of the switchover) before programming the data plane processors with states that incorporate the loss of the data plane components on the previous active supervisor module.

The configurations described above in connection with reducing data plane traffic loss in connection with supervisor switchover are merely illustrative. If desired, the above configurations of network device(s) and/or other configurations of network device(s) may be used to impart these benefits and/or other benefits. Details for these illustrative network device configurations are described herein.

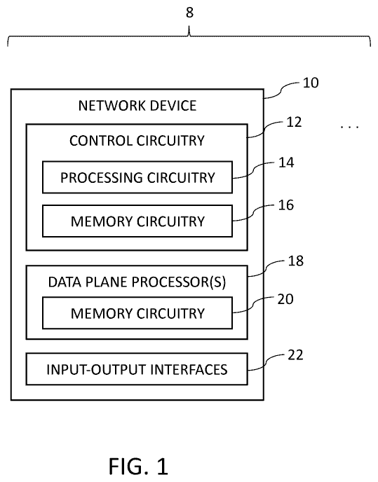

An illustrative network 8 that includes one or more network devices each having multiple supervisors (e.g., configured to reduce data plane traffic loss in the manner described above) is shown in FIG. 1. Network 8 may have any suitable scope. As examples, network 8 may include, be, and/or form part of one or more local segments, one or more local subnets, one or more local area networks (LANs), one or more virtual local area networks (VLANs), one or more campus area networks, one or more metropolitan area networks, one or more wide area networks, one or more datacenter networks, one or more cloud networks, etc. Network 8 may include a wired network (portion) based on wired technologies or standards such as Ethernet (e.g., using copper cables and/or fiber optic cables) and, if desired, may include wireless network portion(s) such as one or more wireless local area networks (WLANs) provided by wireless access point(s). If desired, network 8 may include internet service provider networks (e.g., the Internet) or other public service provider networks, private service provider networks (e.g., multiprotocol label switching (MPLS) networks), and/or other types of networks such as telecommunication service provider networks.

Network 8 may be implemented using and include one or more network devices that handle (e.g., process by switching, routing, modifying, forwarding, etc.) network traffic to convey information for user applications between end hosts and/or for other applications, services, and functions generally between devices (e.g., network devices and/or end host devices). Network 8 may include networking equipment forming a variety of network devices that interconnect end hosts of network 8. As examples, network devices of network 8 may include one or more network switches (e.g., single-layer (Layer 2) switches, multi-layer (Layer 2 and Layer 3) switches, etc.), one or more bridges, one or more routers, one or more gateways, one or more hubs, one or more wireless access points, one or more repeaters, one or more firewalls, one or more devices serving other networking functions, one or more devices that include the functionality of two or more of these devices, and/or management equipment that manages and controls the operation of one or more of other network devices. One such network device of network 8, network device 10, is shown in the example of FIG. 1.

In particular, network device 10 may include control circuitry 12 having processing circuitry 14 and memory circuitry 16, one or more data plane processors 18 and corresponding data plane processor memory circuitry 20, and input-output interfaces 22 (e.g., network interfaces implemented on exterior-facing ports). In some illustrative configurations sometimes described herein as an example, network device 10 may be or form part of a modular network device (e.g., a modular network device system having removably coupled modules usable to flexibly expand characteristics and capabilities of the modular network device system such as to increase the number and/or types of ports, to increase network traffic processing bandwidth or other capabilities, to provide specialized functionalities, etc.). In other configurations, network device 10 may be a fixed-configuration network device (e.g., a fixed-configuration network device having a fixed number of ports and/or a fixed hardware configuration).

Processing circuitry 14 may include one or more processors such as central processing units (CPUs), graphics processing units (GPUs), microprocessors, general-purpose processors, host processors, microcontrollers, digital signal processors, programmable logic devices such as field programmable gate array (FPGA) devices, application specific system processors (ASSPs), application specific integrated circuit (ASIC) processors, and/or other types of processors.

Processing circuitry 14 may run (e.g., execute) a network device operating system and/or other software (including firmware) that is stored on memory circuitry 16 communicatively coupled to processing circuitry 14. Memory circuitry 16 may include one or more non-transitory (tangible) computer-readable storage media that store the operating system software and/or any other software code, sometimes referred to as program instructions, software, data, instructions, or code. As an example, network device control plane functions may be stored as (software) instructions on the one or more non-transitory computer-readable storage media (e.g., in portion(s) of memory circuitry 16). The corresponding processing circuitry (e.g., one or more processors of processing circuitry 14) may execute the respective instructions to perform the corresponding operations. Memory circuitry 16 may include non-volatile memory device(s) (e.g., solid-state drives, flash memories or other electrically-programmable read-only memories, hard disk drive storage devices, etc.), volatile memory device(s) (e.g., static or dynamic random-access memories), and/or other storage circuitry. Processing circuitry 14 and memory circuitry 16 (e.g., at least some portions of both) as described above may collectively form control circuitry 12 (e.g., implementing a control plane of network device 10). Accordingly, processing circuitry 14 may sometimes be referred to as control plane processing circuitry or one or more control plane processors.

In particular, processing circuitry 14 may execute network device control plane software such as operating system software, routing policy management software, routing protocol agents or processes, routing information base agents, and other control software, may be used to support the operation of protocol clients and/or servers, may be used to support the operation of data plane processor(s) 18, may store packet forwarding information, may execute packet processing software, and/or may execute other software instructions that control the functions of network device 10 and the other components therein.

Data plane processor(s) 18 may be used to implement a data plane or forwarding plane of network device 10 and may therefore sometimes be referred to herein as data plane processing circuitry. Data plane processor(s) 18 may be implemented as or include packet processor(s). Data plane processor(s) 18 may include one or more processors such as application specific integrated circuit (ASIC) processors, programmable logic devices (e.g., field programmable gate array (FPGA) devices), application specific system processors (ASSPs), central processing units (CPUs), graphics processing units (GPUs), microprocessors, general-purpose processors, host processors, microcontrollers, digital signal processors, and/or other types of processors.

A data plane processor 18 may receive incoming network packets via input-output interfaces 22 (and/or via device internal interfaces), parse and analyze the received network packets, process the packets based on packet forwarding decision data and/or in accordance with network protocol(s) or other traffic policy, and/or forward (or drop) the network packet accordingly.

To appropriately process network traffic (e.g., network packets), each data plane processor 18 may operate with data plane processor memory circuitry 20. Data plane processor 18 and memory circuitry 20 may be integrated as parts of the same integrated circuit die (or integrated circuit die package). If desired, data plane processor 18 and memory circuitry 20 may be formed as separate discrete processor and memory components (e.g., as a packet processor integrated circuit die and a memory integrated circuit die). In some illustrative configurations described herein as an example, memory circuitry 20 on which flow entries are stored may include ternary content addressable memories (TCAMs). If desired, entries for network traffic matching may be stored in other types of data plane processor memory circuitry in addition to or instead of TCAMs. As desired, memory circuitry 20 may include non-volatile memory device(s) (e.g., solid-state drives, flash memories or other electrically-programmable read-only memories, hard disk drive storage devices, etc.), volatile memory device(s) (e.g., static or dynamic random-access memories), and/or other storage circuitry.

To interact with external devices, external systems, and/or users, network device 10 may include input-output interfaces 22 formed from corresponding input-output devices (sometimes referred to as input-output circuitry or interface circuitry). Input-output interfaces 22 may include different types of communication interfaces such as Ethernet interfaces (e.g., formed from one or more Ethernet ports), optical interfaces (e.g., formed from optical modules containing optical transceivers), WLAN interfaces, and/or other network interfaces for connecting device 10 to the Internet, local area network(s), wide area network(s), WLAN network(s), generally network device(s) in these networks, and/or other computing equipment (e.g., end hosts, server equipment, administrator devices, etc.).

As an example, some input-output interfaces 22 (e.g., those based on wired communication) may be implemented on physical ports. These physical ports may be configured to physically couple to and/or electrically connect to corresponding mating connectors of external components or equipment (e.g., cables, pluggable optical transceiver modules, etc.). Different ports may have different form-factors to accommodate different cables, different modules, different devices, or generally different external equipment. As another example, some input-output interfaces 22 (e.g., those based on wireless communication) may be implemented using wireless communications circuitry (e.g., antennas, transceivers, radios, etc.).

The components of network device 10 described in connection with FIG. 1 are merely illustrative. If desired, network device 10 may include any other suitable components. As examples, device 10 may include power management and/or supply circuitry and may include a system bus and/or other signal paths that communicatively couple the components of network device 10 to one another, that provide the components of network device 10 with power from the power management and/or supply circuitry, etc. In general, each component of network device 10 may be communicatively coupled to control circuitry 12 (e.g., processing circuitry 14 and/or memory circuitry 16) via one or more signal paths that enable the reception and transmission of control signals, data, and/or other information therebetween.

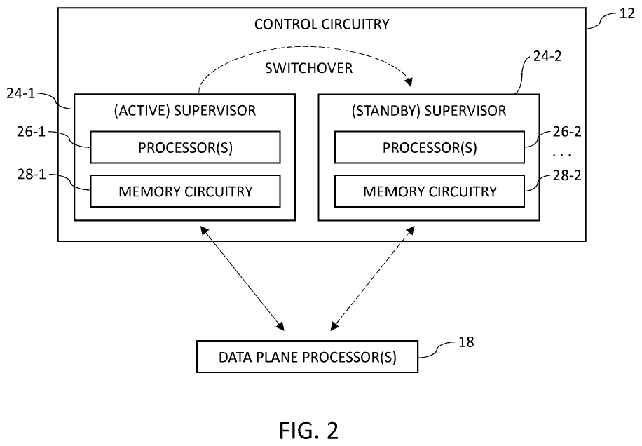

Network device 10 may include multiple supervisors that provide redundancy for control plane operations. FIG. 2 is a diagram of illustrative control circuitry 12 of network device 10 (FIG. 1) implemented using multiple supervisors 24. In the example of FIG. 2, control circuitry 12 may include a first supervisor 24-1 and one or more additional supervisors (e.g., a second supervisor 24-2). Supervisors 24 may each include and be implemented using a portion of processing circuitry 14 in FIG. 1, such as processor(s) 26-1 for supervisor 24-1 and processor(s) 26-2 for supervisor 24-2. Supervisors 24 may each also include and be implemented using a portion of memory circuitry 16 in FIG. 1, such as memory circuitry 28-1 for supervisor 24-1 and memory circuitry 28-2 for supervisor 24-2.

In some illustrative configurations described herein as an example, supervisors 24 (e.g., supervisors 24-1 and 24-2) may each be operable to perform at least some of the same (control plane) functions (e.g., when the respective processing circuitry 26 thereof is configured to execute corresponding control plane software instructions). While supervisors 24 are configurable and operable to perform at least some of the same functions, only one supervisor 24 may actively perform these functions at a given time and is referred to as an active supervisor. The other supervisor(s) 24 that operate with the active supervisor 24 at the given time may be referred to as standby supervisor(s). The active-standby roles of supervisors 24 may change over time (e.g., switch between supervisors 24-1 and 24-2, switch to and from other supervisors, etc.).

In the example of FIG. 2, supervisor 24-1 may initially serve as the active supervisor of control circuitry 12, currently controlling the operation of device 10 (e.g., the components, such as data plane processor(s) 18, in device 10). Supervisor 24-2 may serve as the standby (or backup) supervisor, which, while not currently controlling the operation of device 10, is ready to assume the role of the active supervisor when needed (e.g., when supervisor 24-1 is removed from device 10 or experiences an unexpected failure event, during a planned event such as a maintenance or update event for supervisor 24-1, etc.).

Illustrative sets of operations performed by and described herein in connection with (active) supervisor 24-1 and (standby) supervisor 24-2, respectively, may change once the roles of these supervisors change. As an example, when supervisor 24-2 becomes the new active supervisor (and, if desired and applicable, when supervisor 24-1 becomes the new standby supervisor) after a switchover operation, (new active) supervisor 24-2 may perform the operations described herein to be performed by (previous active) supervisor 24-1 and (new standby) supervisor 24-1 may perform the operations described herein to be performed by (previous standby) supervisor 24-2.

Examples described herein in which device 10 includes two supervisors (e.g., supervisors 24-1 and 24-2) are merely illustrative. If desired, device 10 (e.g., control circuitry 12) may include more than two supervisors 24, one active supervisor 24 and two or more standby supervisors 24, e.g., with an order of priority among the multiple standby supervisors 24. In particular, a highest priority (or otherwise selected) standby supervisor 24 of the multiple standby supervisors 24 may be the one to assume the role of active supervisor when needed. For example, standby supervisor 24-2 in FIG. 2 may be the highest priority (or otherwise selected) standby supervisor, among multiple standby supervisors forming control circuitry 12, that is configured to be ready to assume the role of active supervisor when needed.

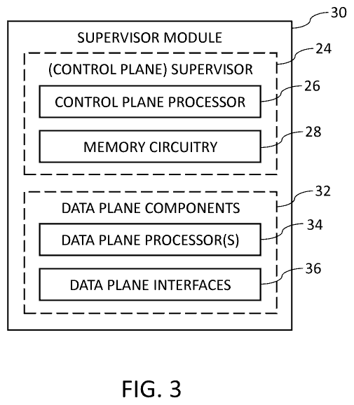

In some illustrative configurations described herein as an example, corresponding hardware for each control plane supervisor 24 (e.g., each set of processor(s) 26, memory circuitry 28, interfaces 22 (FIG. 1), and/or other components for a supervisor 24) may be provided on a different supervisor module. FIG. 3 is a diagram of an illustrative supervisor module 30. Supervisors 24-1 and 24-2 in FIG. 2 may be provided on two instances of supervisor module 30 in FIG. 3 (sometimes referred to herein as supervisor module 30-1 and supervisor module 30-2).

A supervisor module 30 may include the control plane processor 26 and memory circuitry 28 that implement the functionality of a supervisor 24 as described in connection with FIG. 2. Control plane processor 26 of a module 30 may be one processor of processing circuitry 14 of (modular) network device 10. Memory circuitry 28 of a module 30 may be a part of memory circuitry 16 of (modular) network device 10.

In illustrative configurations sometimes described herein as an example, supervisor module 30 may additionally include data plane components 32 such as data plane processor(s) 34 and data plane interfaces 36. Data plane components 32 may implement a portion of the (modular) network device data plane (e.g., implement the network traffic processing functionality described in connection with FIG. 1 for network device 10). Data plane processor(s) 34 of a module 30 may be one or more processors of data plane processing circuitry 18 of (modular) network device 10. Data plane interfaces 36 of a module 30 may be (e.g., form) some of interfaces 22 of (modular) network device 10. In some illustrative configurations described herein, data plane interfaces 36 for a supervisor module 30 may include (uplink) interfaces formed from front-panel uplink ports (e.g., connecting away from local end hosts). If desired, module 30 may include other types of interfaces (e.g., implemented on other types of ports), such as downlink interfaces formed from front-panel downlink ports (e.g., connecting towards local end hosts).

Each module 30 may include a separate printed circuit substrate on which the set of supervisor module components, such as processor 26, memory circuitry 28, processor(s) 34, interfaces 36, and/or other network device components as described in connection with FIGS. 1-3) are mounted or otherwise provided. Components of each module 30 may be communicatively coupled to one another (e.g., using signal paths, such as those for a communication bus, implemented using conductive traces on the substrate, wires, connectors, etc.).

Respective supervisor modules 30-1 and 30-2 for corresponding supervisors 24-1 and 24-2 may be removably attached, mounted, or otherwise coupled to the chassis of a modular network device system (e.g., network device 10). The modular network device system (e.g., device 10) may be configured to removably receive any number of other modules, such as other supervisor modules, input-output module(s) (e.g., line cards or line card modules), midplane modules, backplane modules, fabric module(s) (e.g., fabric cards or fabric card modules, etc.), etc., each configured to be removably attached, mounted, or otherwise coupled to the chassis of the modular network device system.

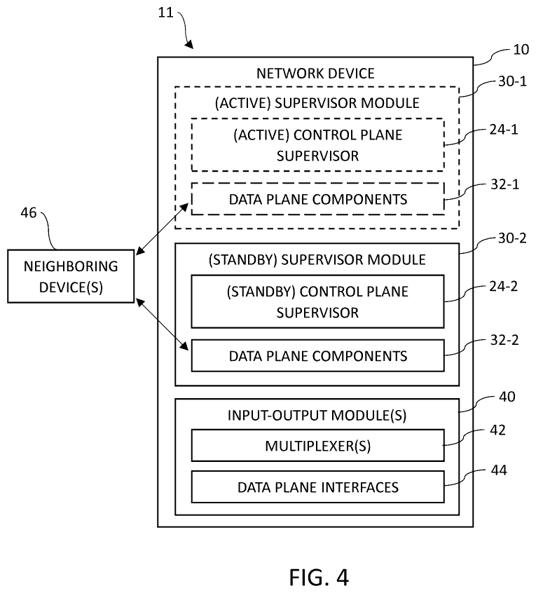

An illustrative modular implementation of a network device (e.g., network device 10 in FIG. 1) is shown in FIG. 4. As shown in FIG. 4, network device 10 may include a chassis 11 (sometimes referred to as a frame or housing) that provides support for and houses the fixed components of network device 10 and also the removably coupled (e.g., swappable) components of network device 10, such as the modules implementing the various functions of the modular network device. Each of these modules may be received through openings in chassis 11, may be physically secured to chassis 11, and may be electrically connected to other components of device 10 when received by and secured to chassis 11 such that these different components are communicatively coupled to each other to collectively operate in the modular network device 10. These modules (e.g., components therein) may be communicatively coupled to one another using signal paths e.g., implemented using wires, connectors, etc.

In the example of FIG. 4, network device 10 may include (e.g., have received in its chassis) a first supervisor module 30-1, a second supervisor 30-2, and one or more input-output modules 40. In some illustrative configurations described herein as an example, supervisor modules 30-1 and 30-2 may each be configured in the manner described in connection with module 30 of FIG. 3. If desired, modules 30-1 and/or 30-2 may be configured in a different manner. When modules 30-1 and 30-2 are implemented in the manner described in connection with FIG. 3, each of these two modules may include supervisor components implementing supervisor 24 (e.g., processor 26, memory circuitry 28, etc., as described in connection with FIGS. 2 and 3) and data plane components 32 (e.g., processor(s) 34, interfaces 36, etc., as described in connection with FIG. 3).

Supervisor 24-1 of module 30-1 may be configured to perform active supervisor operations, thereby providing an (active) supervisor module, and supervisor 24-2 of module 30-2 may be configured to perform standby supervisor operations, thereby providing a (standby) supervisor, e.g., as described in connection with FIG. 2. Regardless of the roles of the supervisor 24-1 of module 30-1 and supervisor 24-2 of module 30-2, data plane components 32-1 of module 30-1 and data plane components 32-2 of module 30-2 may both be operational and active in processing network traffic (e.g., switching, modifying, forwarding, dropping, and/or performing other operations on network packets). In some illustrative examples described herein, data plane components 32-1 and 32-2 may include respective interfaces 36-1 and 36-2 both communicatively coupled to each of one or more neighboring devices 46 (e.g., other network devices of network 8 in FIG. 1 in the uplink direction away from hosts). Interfaces 36-1 and 36-2 coupled to the same neighboring device 46 via corresponding links may be configured as members (e.g., interfaces) of the same equal-cost multi-path (ECMP) routing group and/or may be configured as members (e.g., interfaces) of the same link aggregation group (LAG).

In some illustrative configurations described herein as an example, input-output module(s) 40 of network device 10 may include data plane interfaces 42 through which network traffic is ingressed and egressed from network device 10. Input-output module(s) 52 may include multiplexing circuitry (e.g., multiplexer(s) 42) that provides the network traffic ingressed at each interface 44 to the appropriate (internal) interface of the appropriate one of supervisor modules 30-1 or 30-2 and that provides the network traffic to be egressed from each (internal) interface of supervisor modules 30-1 and 30-2 to the appropriate interface 44 for egress. Supervisor modules 30-1 and 30-2 may each include data plane processor(s) 34 that perform the processing of received network traffic and output (e.g., forward) the processed network traffic via interfaces 36 (e.g., formed on uplink ports) on the corresponding supervisor module for egress. Interfaces 36 of modules 30-1 and 30-2 may also serve as ingress interfaces that receive network traffic. Data plane processor(s) 34 of modules 30-1 and 30-2 may perform the processing of received network traffic and output (e.g., forward) the processed network traffic via interfaces 44 (e.g., using input-output module(s) 40, multiplexer(s) 42 therein).

This example of a modular network device shown in FIG. 4 is merely illustrative. If desired, some of data plane processor(s) 18 may be provided on input-output module(s) 40 in addition to or instead of multiplexer(s) 42 (e.g., multiplexing circuitry may be implemented as part of the data plane processor(s)). If desired, device 10 may include other modules such as midplane modules, backplane modules, and/or generally fabric modules each having data plane interfaces (e.g., implementing some of interfaces 22 or internal interfaces of device 10) and/or data plane processors (e.g., implementing some of processor(s) 18 of device 10). These data plane components of device 10 (e.g., of modules 30-1, 30-2, and 40 and/or of other modules) may collectively implement the data plane of device 10.

While providing data plane components in supervisor modules 30 can improve their functionality, issues may arise during switchover from an active supervisor (e.g., supervisor 24-1) to a standby supervisor (e.g., supervisor 24-2) due to the presence of these data plane components. In particular, in scenarios in which the entire active supervisor module (e.g., module 30-1) is lost or non-operational (e.g., is no longer operational or is removed), the data plane of network device 10 is adversely affected, along with the control plane supervisor. This may, for example, be caused by the entire active supervisor module being removed (e.g., pulled, disconnected, etc.) from the chassis of the modular system, whether intentionally or unintentionally. While stateful switchover and graceful restart of protocols may be performed by the new active (previous standby) supervisor (e.g., supervisor 24-2) to properly take over control plane operations of the network device, the loss of the previous active supervisor module also causes link down events at the data plane interfaces of the previous active supervisor module (e.g., module 30-1). Only after graceful restart and/or other stateful switchover processes have been completed will the new active supervisor take into account the loss of the data plane interfaces of the previous active supervisor module and update the programming of other data plane components (e.g., processors 18) of device 10 accordingly. This can cause prolonged blackholing of traffic at the lost data plane interfaces of the previous active supervisor module at least from the time at which the previous active supervisor module was lost to the time at which the switchover operation has been completed and the programming of data plane components have been updated to account for the lost data plane interfaces of the previous active supervisor module.

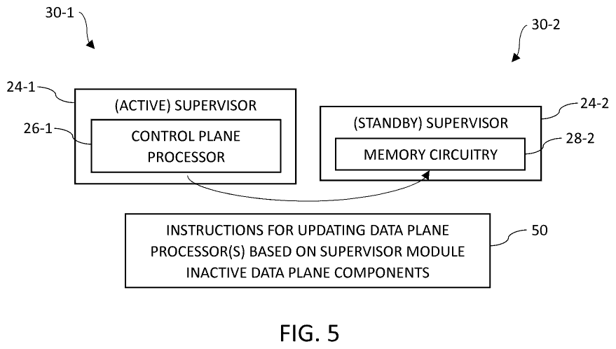

To mitigate these types of issues and reduce the time period during which blackholing occurs at the non-operational (or lost) data plane interfaces of the previous active supervisor module, an active supervisor may prepare the rest of the components of the network device for the possible loss of its data plane components (e.g., data plane interfaces on the active supervisor module). FIGS. 5-8 show illustrative examples in which the active supervisor (e.g., active supervisor 24-1) prepares the standby supervisor (e.g., standby supervisor 24-2) to perform programming of data plane hardware (e.g., data plane processors 18) to account for the loss of data plane components (e.g., components 32-1 in FIG. 4) on the active supervisor module (e.g., module 30-1) if the active supervisor module is no longer active. The preparation may occur prior to the active-standby switchover and the programming of the data plane hardware may be performed by the new active supervisor early on during the active-standby switchover operation, thereby shortening the time period during which blackholing occurs at the lost data plane interfaces of the previous active supervisor module (e.g., shortening the outage time and reducing the amount of traffic loss).

As shown in FIG. 5, an active supervisor such as supervisor 24-1 may include (e.g., be implementing using) a control plane processor 26-1 (e.g., a CPU or another type of processor described in connection with control plane processing circuitry 14 of FIG. 1). Prior to active-standby switchover, control plane processor 26-1 may be configured to generate (software) one or more instructions 50, and/or other information, for updating data plane hardware (e.g., data plane processor(s) 18 of device 10) based on future loss of data plane components on the (currently active) supervisor module (e.g., data plane components 32-1 of module 30-1 on which supervisor 24-1 is provided). In particular, processor 26-1 may determine the appropriate data plane hardware states (e.g., the appropriate states for data plane processor(s) 18) to be programmed into the data plane processor(s) 18 in the event of data plane components on supervisor module 30-1 being lost or non-operational to network device 10 (e.g., module 30-1 is removed from device 10). Instruction(s) 50 may contain, specify, or otherwise indicate the appropriate data plane hardware states (sometimes referred to herein as data plane hardware state information).

Control plane processors 26-1 may provide instruction(s) 50 to a standby supervisor such as supervisor 24-2 for storage on standby supervisor memory circuitry 28-2. Control plane processor 26-2 (FIG. 2) may be configured to store instruction(s) 50 (e.g., indicating the active-supervisor-determined data plane hardware states) and execute instruction(s) 50 at the appropriate time (e.g., after switchover has been initiated, as one of the steps of performing the switchover, generally if one or more criteria have been satisfied, etc.) to actually program the data plane processor(s) 18 with the active-supervisor-determined data plane hardware states (e.g., indicated by instruction(s) 50).

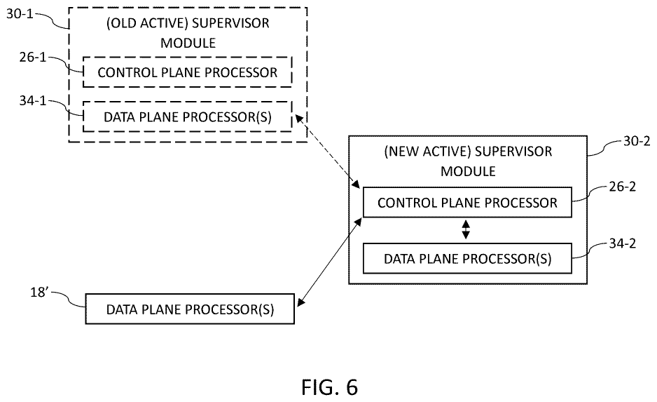

FIG. 6 is a diagram of an illustrative (new, or incoming, active) supervisor module such as supervisor module 30-2 (e.g., the supervisor module containing previous standby supervisor 24-2 of FIG. 5 implemented by processor 26-2) following initiation of switchover. In particular, control plane processor 26-2 (e.g., a CPU or another type of processor described in connection with control plane processing circuitry 14 of FIG. 1) of module 30-2 implementing new active supervisor 24-2 may have determined that previous (old) active supervisor 24-1 (e.g., implemented by corresponding control plane processor 26-1 of module 30-1) is no longer active and may have initiated switchover (e.g., stateful switchover) based on this determination.

As part of the switchover operation, processor 26-2 (e.g., new active supervisor 24-2) may obtain (e.g., take over, from old active supervisor 24-1) access to data plane processor(s) 18 of network device 10. The data plane processor(s) 18 of network device 10 may include data plane processors 34-1 of module 30-1, data plane processors 34-2 of module 30-2 and/or other data plane processors 18′ of other modules of device 10 (e.g., data plane processor(s) of other supervisor modules, of input-output modules, of fabric modules, etc.), if present. Upon determining that data plane processor(s) 34-1, and consequently data plane interfaces 36 (FIG. 3), of old active supervisor module 30-1 are inaccessible to new active supervisor 24-2 (e.g., to control plane processor 26-2 of supervisor 24-2), new active supervisor processor 26-2 may determine that both control plane supervisor 24-1 and data plane components 32-1 of previous active supervisor module 30-1 are non-operational (e.g., are absence or have been removed from device 10, are faulty, are disconnected, etc.), rather than just control plane supervisor 24-1 being lost.

In illustrative configurations sometimes described herein as an example, processor 26-2 determining that data plane components 32-1 of module 30-1 is non-operational may serve as a criterion that is satisfied to perform the execution of instructions 50 provided prior to switchover and stored on memory circuitry 28-2 (FIG. 5). If desired, other criteria may be used instead of or in addition to this criteria to perform the execution of instructions 50.

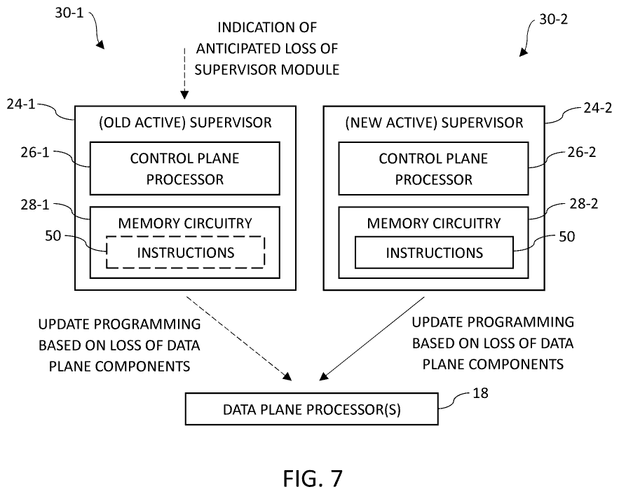

Accordingly, as shown in FIG. 7, control plane processor 26-2 (e.g., new active supervisor 24-2) may execute instructions 50 stored on memory 28-2 and provided by old active supervisor 24-1 prior to switchover (as described in connection with FIG. 5). The execution of instructions 50 by processor 26-2 may update programming of data plane processor(s) 18 on network device 10 with pre-determined hardware states based on (e.g., to account for) the loss of the data plane components 32-1 (FIG. 4) of old active supervisor module 30-1. Because instructions 50 (and corresponding hardware states) are pre-determined by supervisor 24-1 (when it was serving as the active supervisor) and are not generated by new active supervisor 24-2 upon switchover, instructions 50 may be executed early on during the switchover operation (e.g., prior to graceful restarts of protocols or other routing-based computations, prior to network state convergence or hardware state convergence, etc.), thereby reducing the outage or traffic loss time due to loss of data plane components 32-1 of old active supervisor module 30-1.

In some illustrative configurations sometimes described herein as an example, prior to being lost (e.g., being removed from network device 10), (then) active supervisor processor 26-1 may receive an indication of anticipated loss of supervisor module 30-1 (e.g., removal from modular device 10). The indication may be a signal caused by (e.g., produced by) sensor output indicating that supervisor module 30-1 is released from (a locked position within) network device chassis 11 (e.g., by use of an ejector handle, latch, button, and/or other release mechanisms) and is about to be removed (entirely) from network device chassis 11 (and consequently device 10). Responsive to this indication, (then) active supervisor processor 26-1 may execute the same instructions 50 (and corresponding hardware states) provided to (then) standby supervisor 24-2 (e.g., for storage at memory circuitry 28-2). In other words, when instructions 50 are provided to (then) standby supervisor 24-2, a copy of instructions 50 may also be stored locally on memory circuitry 28-1 by processor 26-1.

If processor 26-1 successfully completes execution of instructions 50 (e.g., successfully programs data plane processor(s) 18 with the appropriate hardware states that account for loss of data plane components 32-1 of module 30-1), the subsequent execution of instructions 50 by processor 26-2 (after switchover has been initiated) may have no further effect, because the appropriate hardware states have already been programmed by processor 26-1 (prior to switchover being initiated). Accordingly, the attempt by processor 26-1 to execute instructions 50, in response to the received indication prior to switchover, may further reduce the outage or traffic loss time due to its anticipation of its own loss, e.g., removal. In this scenario, appropriate hardware states may be programmed prior to switchover being initiated, instead of early on during switchover operation.

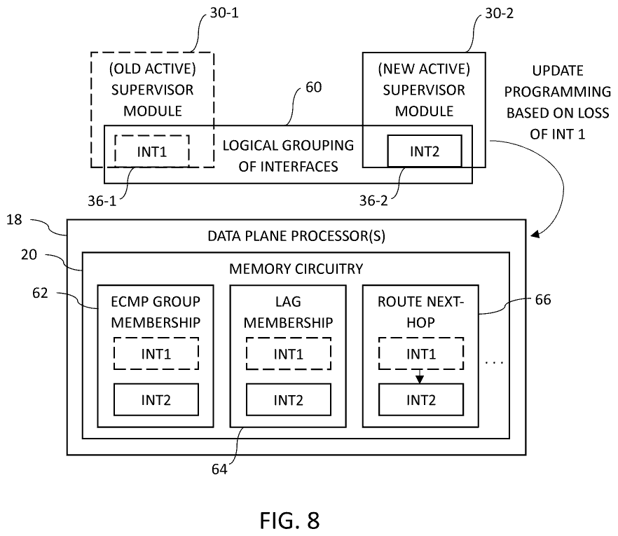

In a scenario in which processor 26-1 does not successfully complete execution of instructions 50 (e.g., does not successfully program data plane processor(s) 18 with the appropriate hardware states that account for loss of data plane components 32-1 of module 30-1) in time (e.g., prior to being removed and disconnected from device 10), the subsequent execution of instructions 50 by processor 26-2 (after switchover has been initiated) may proceed as described above in connection with FIG. 8 to program data plane processor(s) 18 with the appropriate hardware states that account for loss of data plane components 32-1 of module 30-1.

FIG. 8 is a diagram of illustrative types of hardware state updates for data plane processor(s) 18 determined by active supervisor processor 26-1 prior to switchover and performed by active supervisor processor 26-1 prior to switchover and/or by new active supervisor processor 26-2 after switchover initiation (e.g., as described in connection with FIG. 7). One or more of these types of hardware state updates may be determined for and included in or otherwise indicated by instructions 50 (e.g., as described in connection with FIGS. 5 and 7).

In the example of FIG. 8, supervisor module 30-1 (e.g., containing active supervisor 24-1 prior to switchover) may include a first set of one or more data plane interfaces 36-1 (sometimes referred to and shown as INT1 herein) formed from front-panel ports (e.g., uplink ports). Supervisor module 30-2 (e.g., containing standby supervisor 24-2 prior to switchover, and new active supervisor 24-2 after switchover) may include a second set of one or more data plane interfaces 36-2 (or sometimes referred to and shown as INT2 herein) formed from front-panel ports. As described in connection with FIG. 4, a corresponding pair of interfaces 36-1 and 36-2 may be communicatively coupled to each neighboring device 46 via corresponding links (e.g., a first link between a given interface 36-1 and device 46 and a second link between interface 36-2 and the same device 46). These interfaces 36-1 and 36-2 to the same device 46 (e.g., their corresponding links) may be configured to be in the same ECMP (routing) group, in the same LAG, and/or in any other logical groupings 60 of interfaces 36-1 and 36-2, based on programming data plane processor(s) 18 with the corresponding hardware state.

Accordingly, instructions 50 generated by supervisor 24-1 based on the loss or anticipated loss of data plane interfaces 36-1 (e.g., connecting to all neighboring devices 46) may provide updated hardware states for hardware states associated with (e.g., that include, use, indicate, etc.) data plane interfaces 36-1, such as ECMP group membership, LAG membership, and/or other logical group membership of groupings 60. In particular, the updated hardware states may include hardware state(s) that exclude data plane interfaces 36-1 (e.g., in the case of logical groups that originally included interfaces 36-1), may include hardware state(s) that include replacement interfaces such as interfaces 36-2 for interfaces 36-1 (e.g., in the case of next-hop or other route information originally referencing interfaces 36-1), may include other types of hardware(s) that account for interface(s) 36-1 being non-operational. As shown in FIG. 8, instructions 50 (when executed by supervisor processor 26-1 and/or supervisor processor 26-2) may update programming of data plane processor(s) 18 by providing updated hardware state information to be maintained on data plane memory circuitry 20 of each processor 18 based on the loss or anticipated loss of interfaces 36-1.

As examples, instructions 50 may include an instruction 50 that updates ECMP group membership 62 for each ECMP group containing an interface 36-1 to exclude the interface 36-1, may include an instruction 50 that updates LAG membership 64 for each LAG group containing an interface 36-1 to exclude the interface 36-1, and/or may include other instruction(s) 50 that update logical group membership for each logical group containing an interface 36-1 to exclude the interface 36-1. In the example of FIG. 8, membership for each logical group is shown to include only interface 36-1 and interface 36-2, with interface 36-1 being removed by update to leave interface 36-2 in the logical group. This example is merely illustrative. In other network configurations and/or other network device configurations, interface 36-1 may be included in logical groups with other interfaces (instead of or in addition to interface 36-2). Interfaces 36-1 may similarly be removed from the membership of these logical groups.

While instructions 50 to update hardware states associated with logical groupings including interface 36-1 are described above as examples, these examples are merely illustrative. Interfaces 36-1 may be referenced or otherwise indicated in other types of hardware states stored on memory circuitry 20 of each processor 18. If desired and applicable, any of these other types of hardware states indicating interfaces 36-1 may be appropriately updated by instructions 50. As an example of other types of hardware states being updated, memory circuitry 20 may store a next-hop 66 for one or more routes. Instructions 50 may include an instruction 50 that updates route next-hop (information) 66 to replace an interface 36-1 with a corresponding interface 36-2 (e.g., connected to the same neighboring device 46 as the replaced interface 36-1). The use of an interface 36-2 as a replacement for interface 36-1 is merely illustrative. In other network configurations and/or other network device configurations, another interface may be used as the replacement interface (e.g., one or more route next-hops previously indicating interface 36-1).

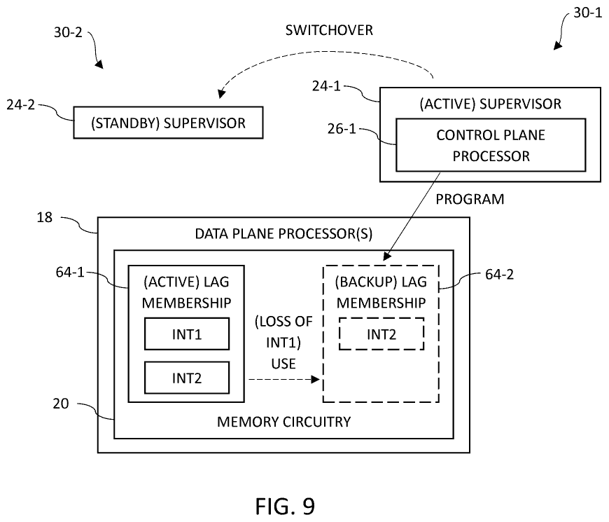

The operations described in connection with FIGS. 5-8 are merely illustrative. If desired, other types of operations may be performed in preparation for the loss of data plane components 32-1 on supervisor module 30-1. As one illustrative example described in connection with FIG. 9, prior to switchover, control plane processor 26-1 (implementing active supervisor 24-1) of supervisor module 30-1 may program a backup link aggregation group (LAG), for each active (or primary) link aggregation group that includes data plane interface(s) 36-1, onto memory circuitry 20 of each data plane processor 18. As shown in FIG. 9, memory circuitry 20 may maintain active membership (information) 64-1 for one or more LAG(s) that include interfaces 36-1 and 36-2 (or generally include interfaces 36-1 and other interfaces). Prior to switchover and in preparation for the loss of data plane components 32-1 (e.g., interfaces 36-1), control plane processor 26-1 may program corresponding backup membership (information 64-2) for each of the one or more LAG(s) that excludes interfaces 36-1 (e.g., that only includes interfaces 36-2 and/or other interfaces).

After initiating supervisor switchover (e.g., by incoming active supervisor processor 26-1, responsive to determining that outgoing active supervisor 24-1 is no longer active), data plane processor(s) 18 may detect that the link status(es) of data plane interface(s) 36-1 of outgoing active supervisor module 30-1 are down (e.g., inactive) and may switch to using the corresponding backup LAG membership 64-2 instead of the primary LAG membership 64-1 in response to the link status(es) of data plane interface(s) 36-2 being down.

Various mechanisms for reducing traffic loss (e.g., outage time) for active-standby (supervisor) switchover are described in connection with FIGS. 5-9. As desired, each of these mechanisms may be used separately or in any suitable combination.

While, in connection with at least some examples described herein (e.g., in connection with FIGS. 1-9), supervisor 24-1 (e.g., processing circuitry 26-1) has been described to perform the operations in connection with preparing the standby supervisor and data plane processor(s) to account for loss of its data plane interfaces during the switchover operation, these operations (and other active supervisor operations) may be performed by supervisor 24-1 in its capacity (role) as the active supervisor. Accordingly, once supervisor 24-2 takes over as the new active supervisor (e.g., after the switchover operation), the new active supervisor 24-2 (e.g., processing circuitry 26-2) may subsequently be configured to perform the operations in connection with preparing the (new) standby supervisor and data plane processor(s) to account for loss of its data plane interfaces during a subsequent switchover operation (and other active supervisor operations) in its capacity (role) as the (new) active supervisor. Analogously, while, in connection with at least some examples described herein (e.g., in connection with FIGS. 1-9), supervisor 24-2 (e.g., processing circuitry 26-2) has been described to perform the operations in connection with programming data plane processors with hardware state information previously received from the outgoing active supervisor during the switchover operation, these operations (and other standby supervisor operations) may be performed by supervisor 24-2 in its capacity (role) as the standby supervisor. Accordingly, once supervisor 24-1 (or another supervisor 24) becomes the new standby supervisor (e.g., after the switchover operation, after being inserted and connected to the chassis of the modular network device, after recovering from the failure event, after completing the maintenance event causing the switchover operation, etc.), the new standby supervisor 24-1 (e.g., processing circuitry 26-1) may then perform the operations in connection with programming data plane processors with hardware state information previously received from the outgoing active supervisor during a subsequent switchover operation (and other standby supervisor operations) its capacity (role) as the (new) standby supervisor.

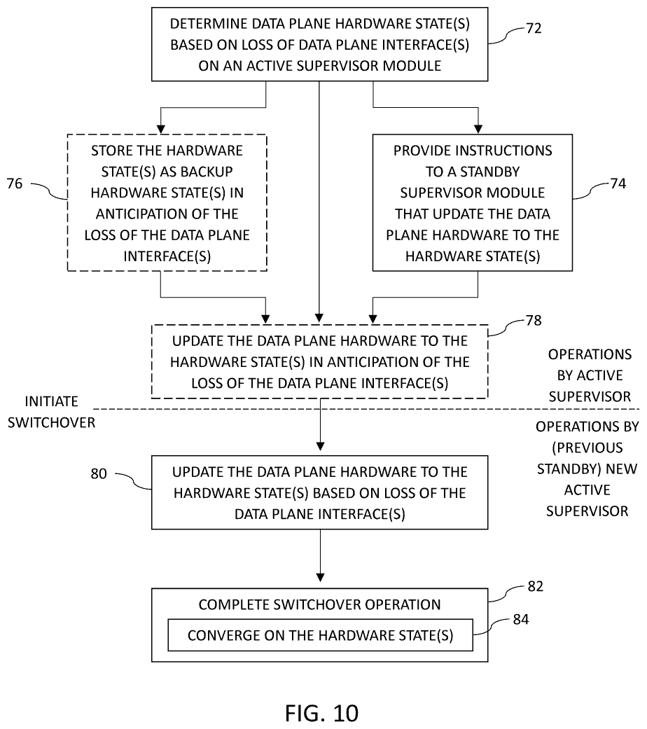

FIG. 10 is a flowchart of illustrative operations for operating a network device, such as a modular network device, or more specifically supervisor module(s) to facilitate switchover when the outgoing (old) active supervisor includes data plane component(s). In particular, these operations may be performed by one or more processors 14 of network device 10 (FIG. 1) such as one or more processors 26 of supervisor 24 in a supervisor module 30 (e.g., one or more processors 26-1 of supervisor 24-1 in supervisor module 30-1, one or more processors 26-2 of supervisor 24-2 in supervisor module 30-2, etc., in FIGS. 2-4) using other components of network device 10 (e.g., other components of supervisor modules 30-1, 30-2, etc., such as memory circuitry 28, supervisor module input-output interfaces, etc.). In some configurations described herein as an illustrative example, at least some of the operations described in connection with FIG. 10 may be performed by one or more processors (e.g., processing circuitry 14, processor(s) 26-1, processor(s) 26-2, other supervisor processors, etc.) executing software instructions stored on memory circuitry (e.g., one or more non-transitory computer-readable storage media of memory circuitry 16, of memory circuitry 28-1, memory circuitry 28-2, etc.). If desired, one or more operations described in connection with FIG. 10 may be performed by and/or use dedicated hardware (processors) of network device 10 (e.g., of supervisor modules 30).

At block 72, processing circuitry of a network device (e.g., control plane processor(s) of an active supervisor on a first supervisor module) determine (e.g., compute) a data plane hardware state based on (anticipated) loss of data plane interface(s) on an active supervisor module (e.g., the first supervisor module on which the active supervisor is implemented). These data plane hardware states may be the hardware states described in connection with FIG. 8 and/or may include other types of hardware states affected by the loss of data plane interface(s) on an active supervisor module. As an example, the operations performed at block 72 may include operations described in connection with FIGS. 8 and 5 and performed by supervisor processor 26-1 (e.g., supervisor 24-1).

The determined data plane hardware states may be used in a number of manners, depending on the type of state information that is determined.

At block 74, the processing circuitry (e.g., the control plane processor(s) of the active supervisor) may provide, to a standby supervisor module, instructions that update the data plane hardware (e.g., data plane processor(s)) of the network device to the determined hardware states. The instructions may contain or otherwise indicate the determined hardware states and may be provided for delayed execution by the standby supervisor (e.g., for execution a variable delay time period after receiving the instructions, for execution at the appropriate stage of the switchover operation, etc.). When these instructions are processed by the standby supervisor processor, the data plane processor(s) of the network device may be programmed with the determined hardware state(s). As an example, the operations performed at block 74 may include operations described in connection with FIGS. 8 and 5 and performed by supervisor processor 26-1 (e.g., supervisor 24-1).

If desired and appropriate, at block 76, the processing circuitry (e.g., the control plane processor(s) of the active supervisor) may store (at least some of) the hardware state(s) as backup hardware state(s) in anticipation of the loss of the data plane interface(s) at the data plane hardware (e.g., data plane processor(s)) of the network device. In one illustrative configuration, the determined hardware state(s) may include backup LAG membership information for one or more LAGs stored as backup hardware state(s). As an example, the operations performed at block 76 may include operations described in connection with FIG. 9 and performed by supervisor processor 26-1 (e.g., supervisor 24-1).

If desired and appropriate, at block 78, the processing circuitry (e.g., the control plane processor(s) of the active supervisor) may update the data plane hardware (e.g., data plane processor(s)) to the hardware state(s) in anticipation of the loss of the data plane interface(s). In particular, the processing circuitry (e.g., the control plane processor(s) of the active supervisor) may execute the same instructions provided to the standby supervisor at block 74 to perform this updating of the data plane hardware. As an example, the operations performed at block 78 may include operations described in connection with FIG. 7 and performed by supervisor processor 26-1 (e.g., supervisor 24-1).

The operations described in connection with blocks 72, 74, 76, and 78 may be performed by the active supervisor before active-standby supervisor switchover (e.g., the process of the standby supervisor becoming the new active supervisor) is initiated. If desired, the operations of one or more of blocks 74, 76, and 78 may be omitted. In scenarios in which the operations of block 74 are omitted (e.g., when the operations of blocks 76 and/or 78 are performed), the operations of block 80 may also be omitted.

As illustrative examples, processing may proceed from block 72 to block 78 (without performing the operations of blocks 76 and 78), processing may proceed from block 72 to block 74, and then to block 78 (with or without performing the operations of block 76), processing may proceed from block 72 to block 76, and then to block 78 (with or without performing the operations of block 74), processing may proceed from block 72 to block 76 and omit the operations of block 78 (with or without performing the operations of block 74), or processing may proceed from block 72 to block 74 and omit the operations of block 78 (with or without performing the operations of block 76),

The order of operations at blocks 72, 74, and 78 are merely illustrative. If desired, some of the operations of one or more of blocks 74, 76, and 78 may be performed concurrently. If desired, some of the operations of one or more of blocks 74, 76, and 78 may be performed sequentially (and not necessarily in the order depicted in FIG. 10).

After the switchover is initiated (e.g., during the active-standby supervisor switchover operation), the operations described in connection with blocks 80 and 82 may be performed by the incoming (new) active supervisor (i.e., the previous standby supervisor).

At block 80, the processing circuitry of the network device (e.g., control plane processor(s) of a previous standby supervisor promoted to a new active supervisor on a second supervisor module) may update the data plane hardware (e.g., data plane processor(s)) of the network device to the hardware state(s) based on loss of the data plane interface(s). The operations at block 80 may be performed as part of (e.g., at the early stages of) the switchover operation. In particular, the processing circuitry (e.g., the control plane processor(s) of the new active supervisor) may execute the instructions provided by and received from the then (old) active supervisor at block 74 to perform this updating of the data plane hardware. As an example, the operations performed at block 80 may include operations described in connection with FIGS. 6-8 and performed by supervisor processor 26-2 (e.g., supervisor 24-2).

At block 82, the processing circuitry (e.g., the control plane processor(s) of the new active supervisor, i.e., the previous standby supervisor) may complete the switchover operation (e.g., perform and complete stateful switchover processes including graceful restart of protocols). As part of completing the switchover operation (e.g., completing graceful restart of (routing) protocols), the processing circuitry (e.g., the control plane processor(s) of the new active supervisor, i.e., the previous standby supervisor) may itself converge on (e.g., determine, calculate, etc.) the appropriate hardware state(s) that account for the loss of the data plane interface(s). These newly determined hardware states may also be programmed into the data plane hardware. The hardware state(s) determined by the new active supervisor at block 82 may be the same as the corresponding hardware state(s) determined by the old active supervisor at block 72. In this scenario, the programming of the newly determined hardware state(s) may not substantively affect the already programmed hardware state(s), which are the same as the newly determined hardware state(s). However, the convergence to these hardware states, at block 84 by the control plane (e.g., the new active supervisor), may provide congruence between control plane determined states and programmed data plane states.

The methods and operations described above in connection with FIGS. 1-10 may be performed by the components of one or more network devices and/or other networking equipment a network using software (including firmware) and/or hardware. Software code for performing these operations may be stored on one or more non-transitory computer-readable storage media (e.g., tangible computer-readable storage media) on one or more of the components of the network device(s) and/or other networking equipment. The software code may sometimes be referred to as software, data, instructions, program instructions, or code. The one or more non-transitory computer-readable storage media may include drives, non-volatile memory such as non-volatile random-access memory (NVRAM), removable flash drives or other removable media, other types of random-access memory, etc. Software stored on the non-transitory computer readable-storage media may be executed by processing circuitry on one or more of the components of the network device(s) and/or other networking equipment (e.g., processing circuitry 14 of network device 10 of FIG. 1, processor(s) 26 of supervisor(s) 24 in corresponding supervisor module(s) 30 in FIGS. 2-4 such as processor(s) 26-1 of supervisor 24-1 in module 30-1 and processor(s) 26-2 of supervisor 24-2 in module 30-2, etc.).

The foregoing is merely illustrative and various modifications can be made to the described embodiments. The foregoing embodiments may be implemented individually or in any combination.

What is claimed is:

1. A supervisor module comprising:
a data plane interface;
a printed circuit substrate;
a data plane processor on the printed circuit substrate and communicatively coupled to the data plane interface;
memory circuitry on the printed circuit substrate; and
control plane processing circuitry on the printed circuit substrate, communicatively coupled to the data plane processor and the memory circuitry, and configured to:
determine data plane hardware state information based on an anticipated loss of the data plane interface; and
perform, prior to a supervisor switchover, one or more operations that facilitate programming of the data plane hardware state information onto one or more additional data plane processors external to the supervisor module.

2. The supervisor module defined in claim 1, wherein the one or more operations comprise conveying, prior to the supervisor switchover, the determined data plane hardware state information to an additional supervisor module.

3. The supervisor module defined in claim 2, wherein the control plane processing circuitry is configured to implement an active supervisor and wherein the determined data plane hardware state information is conveyed in one or more instructions for execution by a standby supervisor of the additional supervisor module to program the one or more additional data plane processors during the supervisor switchover.

4. The supervisor module defined in claim 3, wherein the one or more additional data plane processors comprise a data plane processor of the additional supervisor module.

5. The supervisor module defined in claim 3, wherein the determined data plane hardware state information comprises membership information for one or more logical groupings of interfaces and wherein the membership information for the one or more logical groupings of interfaces excludes the data plane interface.

6. The supervisor module defined in claim 5, wherein the one or more logical groupings of interfaces comprise at least one of an equal-cost multi-path (ECMP) group or a link aggregation group (LAG).

7. The supervisor module defined in claim 3, wherein the determined data plane hardware state information comprises next-hop information for one or more routes, wherein the next-hop information for the one or more routes includes a replacement data plane interface for the data plane interface, and wherein the replacement data plane interface is on the additional supervisor module.

8. The supervisor module defined in claim 1, wherein the one or more operations comprise executing, prior to the supervisor switchover, one or more instructions to program the data plane hardware state information onto the one or more additional data plane processors.

9. The supervisor module defined in claim 8, wherein the control plane processing circuitry is configured to receive a signal indicating that the supervisor module is to be removed from a modular network device chassis and wherein the one or more instructions are executed based on the received signal.

10. The supervisor module defined in claim 1, wherein the data plane hardware state information comprises a backup hardware state and wherein the one or more operations comprise programming, prior to the supervisor switchover, the one or more additional data plane processors with the backup hardware state for storage along with a corresponding primary hardware state.

11. The supervisor module defined in claim 10, wherein the primary hardware state comprises membership information for a primary link aggregation group (LAG) that includes the data plane interface and an additional data plane interface and wherein the backup hardware state comprises membership information for a backup LAG that includes the additional data plane interface and excludes the data plane interface.

12. The supervisor module defined in claim 1, wherein the supervisor module is operable with an additional supervisor module in a modular network device, wherein a first supervisor implemented on the supervisor module serves as an active supervisor prior to the supervisor switchover, wherein a second supervisor implemented on the additional supervisor module serves as a standby supervisor prior to the supervisor switchover, and wherein the second supervisor serves as a new active supervisor after the supervisor switchover.

13. The supervisor module defined in claim 12, wherein the programming of the data plane hardware state information onto the one or more additional data plane processors is facilitated by the performed one or more operations to occur prior to a completion of the supervisor switchover.

14. The supervisor module defined in claim 12, wherein the supervisor switchover is performed based on the supervisor module being removed from a modular network device.

15. A supervisor module operable in a modular network device, the supervisor module comprising:
a data plane interface;
a printed circuit substrate;
a data plane processor on the printed circuit substrate and communicatively coupled to the data plane interface;
memory circuitry on the printed circuit substrate; and
control plane processing circuitry on the printed circuit substrate, communicatively coupled to the data plane processor and the memory circuitry, and configured to:
determine a data plane hardware state based on an anticipated loss of the data plane interface; and
convey, prior to a supervisor switchover operation, the determined data plane hardware state to an additional module in the modular network device.

16. The supervisor module defined in claim 15, wherein the additional module is an additional supervisor module and wherein the determined and conveyed data plane hardware state is indicated in an instruction to the additional supervisor module to update a data plane processor of the modular network device to the determined hardware state during the supervisor switchover operation.

17. The supervisor module defined in claim 16, wherein the control plane processing circuitry is configured to receive an indication of the anticipated loss of the data plane interface and is configured to execute the instruction, based on the received indication, prior to the supervisor switchover operation.

18. The supervisor module defined in claim 17, wherein the additional supervisor module includes an additional data plane interface and wherein the generated and conveyed data plane hardware state comprises:
a logical grouping of interfaces that includes the additional data plane interface and excludes the data plane interface, or
the additional data plane interface as a replacement interface for the data plane interface.

19. A supervisor module operable in a modular network device, the supervisor module comprising:
a printed circuit substrate;
memory circuitry on the printed circuit substrate; and
control plane processing circuitry on the printed circuit substrate, communicatively coupled to the memory circuitry, and configured to:
receive, prior to initiation of a supervisor switchover operation and from an additional supervisor module in the modular network device, data plane hardware state information that anticipates loss of one or more data plane interfaces of the additional supervisor module; and
program, during the supervisor switchover operation, one or more data plane processors of the modular network device with the received data plane hardware state information.

20. The supervisor module defined in claim 19, wherein a first supervisor implemented on the supervisor module serves as a standby supervisor prior to the supervisor switchover operation, wherein a second supervisor implemented on the additional supervisor module serves as an active supervisor prior to the supervisor switchover operation, wherein the first supervisor serves as a new active supervisor after the supervisor switchover operation, and wherein the supervisor switchover operation is initiated based on the additional supervisor module being removed from the modular network device.
